(19) United States
(12) Patent Application Publication
(10) Pub. No.: US 2020/0177754 A1
(43) Pub. Date: Jun. 4, 2020

(54) IMAGE READING APPARATUS

(71) Applicant: KONICA MINOLTA, INC., Tokyo (JP)

(72) Inventor: Hiroaki KUBO, Muko-shi (JP)

(73) Assignee: KONICA MINOLTA, INC., Tokyo (JP)

(21) Appl. No.: 16/675,422

(22) Filed: Nov. 6, 2019

(30) Foreign Application Priority Data
Nov. 30, 2018 (JP) 2018-225908

(51) Int. Cl. H04N 1/00

(52) U.S. Cl. CPC H04N 1/00846; H04N 1/00848; H04N 2201/0094; H04N 1/00875; H04N 1/00883

(57) ABSTRACT

An image reading apparatus includes: a hardware processor that acquires scan data obtained by reading from printed matter outputted by an image forming apparatus; an acquisitor that acquires print data used for image formation of the printed matter from the image forming apparatus; a first determiner that compares the scan data and the print data and detects whether or not the scan data and the print data match; a second determiner that determines whether or not a predetermined reference image is included in the scan data when a determination result by the first determiner is negative; and a first discarder that causes the scan data to be discarded when a determination result by the second determiner is positive.

The entire disclosure of Japanese patent Application No. 2018-225908, filed on Nov. 30, 2018, is incorporated herein by reference in its entirety.

### BACKGROUND

### Technological Field

The present invention relates to an image reading apparatus, and particularly to a technique for inhibiting creation of image data for which duplication is prohibited.

### Description of the Related art

In recent years, for the purpose of managing quality of printed matter outputted by image forming apparatuses, there is a case where a reading apparatus is used to check whether or not scan data obtained by reading printed matter matches original print data. The reading apparatus has a function of saving scan data as history information. When a quality issue is found, a user of the image forming apparatus can check what kind of problem has occurred by referring to the history information.

The reading apparatus can also be used for forgery determination of banknotes and the like in addition to quality control of printed matter (see, for example, JP 2014-113775 A). For example, the reading apparatus can inhibit unauthorized use by storing in advance an image (hereinafter referred to as a “reference image”) that serves as a mark for identifying an image to be protected from forgery, checking whether or not the reference image is included in the scan data, and marking the printed matter so as to inhibit printing or using, or discharging the sheet onto a dedicated tray, when the reference image is included.

However, when the image forming apparatus performs printing using print data obtained by scaling raster image processing (RIP) data including a reference image, the reference image does not match the original reference image since the reference image is scaled in the scan data obtained by reading the printed matter. Therefore, it is not possible to identify an image to be protected from forgery. Saving such scan data as history information may cause abuse of the scan data.

For such a problem, for example, there is considered a measure using reversely scaled data with a sign returned to the original size, by the reading apparatus acquiring a scaling factor from the image forming apparatus and reversely scaling the scan data. This enables detection of the reference image, making it possible to identify the image to be protected from forgery.

However, even if such a measure is taken, there are cases where it is not possible to suppress saving of unauthorized scan data. For example, there is considered an unauthorized act of attaching a banknote or the like to a recording sheet used for the printing, when printing by scaling RIP data that is appropriate in the sense that it does not include a reference image.

In a case where such an unauthorized act is performed, when the reading apparatus acquires a scaling factor from the image forming apparatus and reversely scales the scan data, a part of the scan data that has been read from the banknote attached to the recording sheet is also reversely scaled. As a result, if the reference image included in the image of the banknote is also inversely scaled and is no longer the original size, it is not possible to detect the reference image that is not the original size, disabling identification of the banknote image of the original size included in the scan data.

Therefore, the scan data including the banknote image of the original size is saved as history information and may be illicitly used. Such unauthorized acts are also performed on images other than banknotes, and unauthorized scan data can be saved, so that countermeasures are indispensable.

### SUMMARY

The present invention has been made in view of the above problems, and an object of the present invention is to provide an image reading apparatus that suppresses an unauthorized act of saving scan data including an image, by reading printed matter in which an image is formed on a recording sheet attached with the image.

To achieve the abovementioned object, according to an aspect of the present invention, an image reading apparatus reflecting one aspect of the present invention comprises: a hardware processor that acquires scan data obtained by reading from printed matter outputted by an image forming apparatus; an acquisitor that acquires print data used for image formation of the printed matter from the image forming apparatus; a first determiner that compares the scan data and the print data and detects whether or not the scan data and the print data match; a second determiner that determines whether or not a predetermined reference image is included in the scan data when a determination result by the first determiner is negative; and a first discarder that causes the scan data to be discarded when a determination result by the second determiner is positive.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view showing a main configuration of a multi-function peripheral according to an embodiment of the present invention;

FIG. 2 is a block diagram showing a main hardware configuration of a reading control part and a printer control part;

FIG. 3 is a block diagram showing a main functional configuration of the reading control part and the printer control part;

FIG. 4 is a flowchart showing an operation of the printer control part;

FIG. 5 is a flowchart for explaining a main routine in an operation of the reading control part;

FIG. 6 is a flowchart for explaining quality confirmation processing in an operation of the reading control part;

FIG. 7 is a flowchart for explaining reference image detection processing in an operation of the reading control part;

FIG. 8 is a flowchart showing log processing in an operation of the reading control part;

FIG. 9A is a view showing a flow of printing processing;

FIG. 9B is a table for explaining a relationship between a form of a reference image and detection processing;

FIG. 10 is a flowchart for explaining a main routine in an operation of the reading control part according to a modification in which a reference image is detected every time one band of printed matter is read;

FIG. 11 is a flowchart for explaining quality confirmation processing in an operation of the reading control part according to the modification in which a reference image is detected every time one band of printed matter is read;

FIG. 12 is a view showing a main configuration of a reading apparatus according to a modification of the present invention; and

FIG. 13 is a flowchart for explaining a part of a reference image detection processing in an operation of the reading control part according to a modification of the present invention.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of an image reading apparatus according to the present invention will be described with reference to the drawings, taking a multi-function peripheral (MFP) as an example.

### [1] Configuration of Multi-Function Peripheral

First, a configuration of a multi-function peripheral according to the present embodiment will be described.

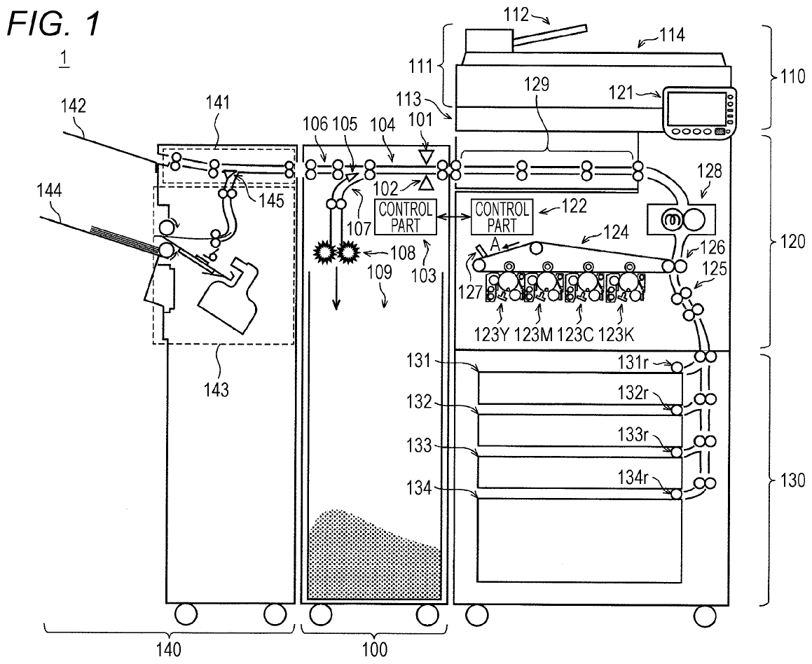

As shown in FIG. 1, a multi-function peripheral 1 includes a reading apparatus 100, a scanner device 110, a printer device 120, a sheet feeding device 130, and a finisher device 140, and performs functions such as printer function, scanner function, copy function, facsimile function, and document server function.

When the scanner device 110 receives a document reading instruction from a user via an operation panel 121 provided on the printer device 120, the scanner device 110 uses an automatic document feeder (ADF) 111 to convey a document one by one from a document bundle placed on a document tray 112 to an image reading part 113, and uses the image reading part 113 to read the document and generate image data. The read document is discharged onto a sheet discharging tray 114.

The printer device 120 is a so-called tandem color printer, and forms an image by an electrophotographic method. Note that a method other than the electrophotographic method such as an ink jet method may be adopted. Further, in consideration of a case where a monochrome confidential document describing a trade secret or the like is illicitly duplicated, the printer device 120 may be a monochrome printer.

The printer device 120 includes a printer control part 122. The printer control part 122 receives a print job from another device such as a personal computer (PC) via a communication network (not shown) such as a local area network (LAN), or accepts a print job by an instruction inputted by the user using the operation panel 121.

Upon receiving a print job at the printer control part 122, in a case of forming a monochrome image, the printer device 120 exclusively use an image forming part 123K to form a toner image of K color, and performs electrostatic transfer (primary transfer) onto an intermediate transfer belt 124. Further, in a case of forming a color image, the printer device 120 uses image forming parts 123Y, 123M, 123C, and 123K to form toner images of individual colors of YMCK, and performs electrostatic transfer (primary transfer) onto the intermediate transfer belt 124 such that the toner images are superimposed on each other. This causes a color toner image to be formed.

The intermediate transfer belt 124 is stretched around a driving roller, a driven roller, and a tension roller, and rotationally travels in a direction of arrow A by rotational driving of the drive roller. The intermediate transfer belt 124 conveys the toner image to a secondary transfer roller pair 126 by the rotational traveling.

The sheet feeding device 130 feeds recording sheets contained in sheet feeding trays 131, 132, 133, and 134 one by one by using pickup rollers 131r, 132r, 133r, and 134r. The sheet feeding device 130 feeds the recording sheet from the sheet feeding tray according to specification of a sheet type in a print job. The fed recording sheet is conveyed by a conveyance roller, and conveyed to the secondary transfer roller pair 126 after skew is corrected by a timing roller 125 and a conveyance timing is adjusted.

A secondary transfer bias voltage is applied to the secondary transfer roller pair 126, which causes the toner image on the intermediate transfer belt 124 to be electrostatically transferred (secondary transferred) onto the recording sheet. Toner remaining on the intermediate transfer belt 124 after the secondary transfer is scraped off by a cleaning blade 127 and discarded. After the toner image is thermally fixed by a fixing part 128, the recording sheet is conveyed toward the reading apparatus 100 via the conveying device 129.

When the reading apparatus 100 receives the recording sheet from the conveying device 129, the reading apparatus 100 reads front and back surfaces of the recording sheet by using line scanners 101 and 102, to generate image data (hereinafter referred to as “scan data”). In a case where the printer device 120 is a color printer, it is desirable to use a color scanner as the line scanners 101 and 102. In a case where the printer device 120 is a monochrome printer, it is desirable to use a monochrome scanner as the line scanners 101 and 102.

Further, the reading apparatus 100 receives a notification from the printer device 120 as to whether single-sided printing or double-sided printing has been performed. When the printer device 120 has performed single-sided printing, the reading apparatus 100 may read a front surface of the recording sheet by using the line scanner 102 alone. When the printer device 120 has performed double-sided printing, the reading apparatus 100 may read a front surface of the recording sheet by using the line scanner 101, and read a back surface by using the line scanner 102.

A reading control part 103 controls an orientation of a path switching claw 105 in accordance with whether or not scan data includes a reference image stored in advance. When a reference image is included, the recording sheet that has passed through a conveyance path 104 is guided to a conveyance path 107 by the path switching claw 105, cut by a cutting roller 108, and then contained in a cutting waste container 109. Whereas, when a reference image is not included, the recording sheet is guided to a conveyance path 106 by the path switching claw 105 and outputted to the finisher device 140.

The finisher device 140 controls an orientation of a path switching claw 145 depending on whether or not post-processing is instructed in a print job. When post-processing is not instructed, the path switching claw 145 guides the recording sheet to a sheet discharging tray 142 via a conveyance path 141. Further, when post-processing is instructed, the path switching claw 145 guides the recording sheet to a post-processing device 143.

The post-processing device 143 performs post-processing, such as alignment of a recording sheet bundle, punching, stapling, and folding, on a recording sheet in accordance with an instruction in a print job. The recording sheet subjected to the post-processing is discharged onto a sheet discharging tray 144.

[2] Hardware configuration of reading control part 103 and printer control part 122

Next, a hardware configuration of the reading control part 103 and the printer control part 122 will be described.
(2-1) Hardware Configuration of Printer Control Part 122

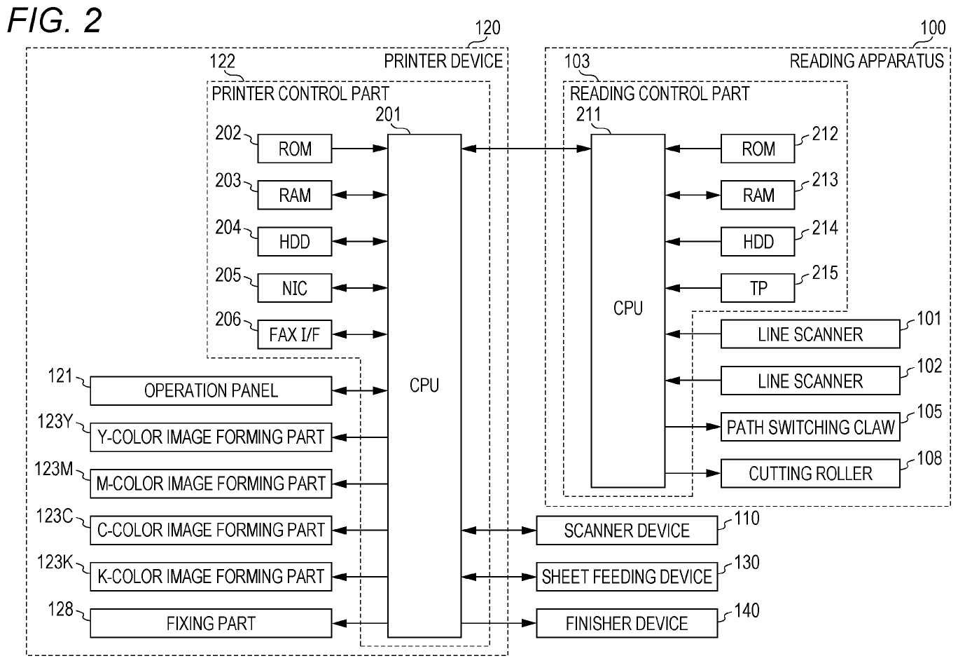

As shown in FIG. 2, the printer control part 122 includes a central processing unit (CPU) 201, a read only memory (ROM) 202, a random access memory (RAM) 203, and the like. When power is applied to the multi-function peripheral 1, the CPU 201 reads a boot program from the ROM 202 to start up, and executes an operating system (OS) and a control program read from a hard disk drive (HDD) 204 with the RAM 203 as a working storage area.

A network interface card (NIC) 205 executes communication processing at a time of accepting a print job from another device or transmitting image data to another device via a communication network such as a LAN. A FAX interface 206 exchanges facsimile data with another facsimile machine via a facsimile line.

By controlling an operation of the operation panel 121, the printer control part 122 presents information to the user of the multi-function peripheral 1 and receives instructions from the user. The instructions include, for example, generation of image data by reading a document, copying using image data, facsimile transmission using image data, execution of print jobs received from another device, and a printout of facsimile data received from another facsimile machine.

When forming an image, the printer control part 122 controls, for example, the image forming parts 123Y, 123M, 123C, and 123K to form toner images of individual colors of YMCK, and thermally fixes the toner image on the recording sheet while controlling a fixing temperature of the fixing part 128. Similarly, the printer control part 122 controls the scanner device 110 to read a document and generate image data, and controls the sheet feeding device 130 to feed a recording sheet specified by a print job or specified by the user with use of the operation panel 121.
(2-2) Hardware Configuration of Reading Control Part 103

Similarly to the printer control part 122, the reading control part 103 includes a central processing unit (CPU) 211, a read only memory (ROM) 212, a random access memory (RAM) 213, and the like. When power is applied to the multi-function peripheral 1, the CPU 211 reads a boot program from the ROM 212 to start up, and executes an operating system (OS) and a control program read from a hard disk drive (HDD) 214 with the RAM 213 as a working storage area.

Consequently, the CPU 211 generates image data from image data for each line outputted by the line scanners 101 and 102 reading the document, determines the presence or absence of a reference image, and controls an orientation of the path switching claw 105 and causes the cutting roller 108 to perform cutting operation depending on the determination result.

In addition, the reading control part 103 includes a touch panel (TP) 215, and can present information to the user of the multi-function peripheral 1 and accept an instruction input from the user.

### [3] Functional Configuration of Reading Control Part 103 and Printer Control Part 122

Next, a functional configuration of the reading control part 103 and the printer control part 122 will be described.
(3-1) Functional Configuration of Printer Control Part 122

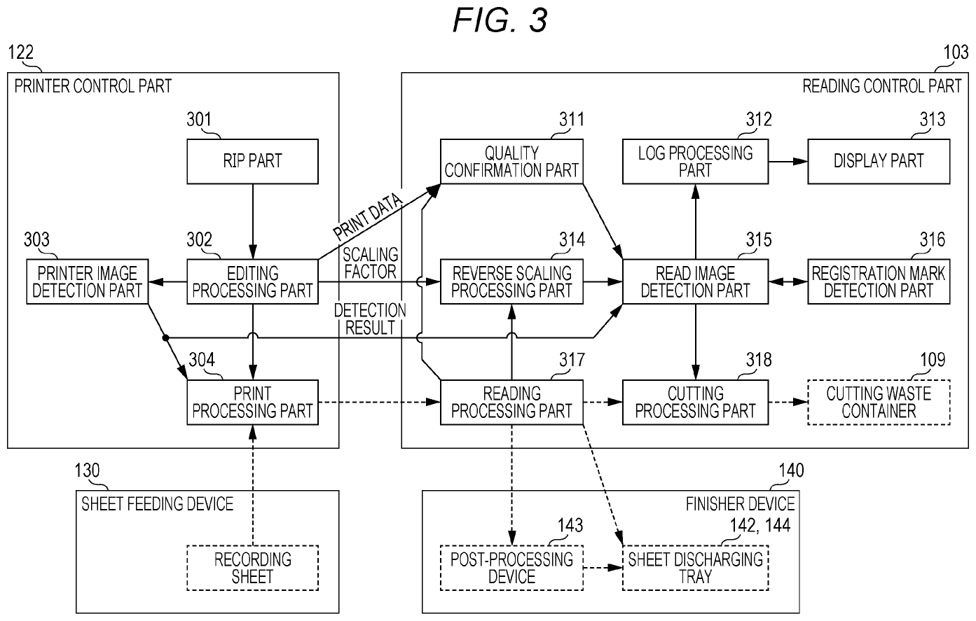

As shown in FIG. 3, the printer control part 122 includes a raster image processor (RIP) part (hereinafter referred to as “RIP part”) 301, an editing processing part 302, a printer image detection part 303, and a print processing part 304. These functions are realized by the CPU 201 executing a control program.

The RIP part 301 generates raster image data (hereinafter referred to as “RIP data”) from image data specified by a print job, by rasterization processing. The print job is described using a page description language such as Postscript, a portable document format (PDF), or XML, paper specification (XPS, XML: extensible markup language). Further, the RIP data is bitmap data.

The editing processing part 302 generates image data (hereinafter referred to as “print data”) obtained by editing the RIP data generated by the RIP part 301. In particular, when a scaling factor is specified in a print job, the RIP data is scaled by the scaling factor. Note that, in the print job, there are a case where a scaling factor is specified by a numerical value and a case where a scaling factor is specified by specifying a layout such as 2in1.

The editing processing part 302 transmits a scaling factor in response to a request from a reverse scaling processing part 314 of the reading control part 103, or transmits print data in response to a request from a quality confirmation part 311. In the present embodiment, as an example, a case will be described where a numerical value representing a scaling factor is transmitted to the reading control part 103 regardless of whether or not a scaling factor is specified using a numerical value in the print job. However, it is needless to say that the scaling factor may be indicated using data other than the numerical value.

The printer image detection part 303 detects whether or not the print data includes a reference image. In the present embodiment, the reference image refers to an image printed on vouchers for which duplication is prohibited, such as banknotes and securities, for determining the authenticity of the vouchers, and an inhibited image that includes an image of a specific pattern, mark, or the like appearing in documents required to be protected from secret leakage. Examples of such an inhibited image include marks or patterns including a character string such as “SECRET” or “CONFIDENTIAL”.

Note that the reference image includes an inhibited image for which duplication is prohibited or an inhibited image indicating that copying is inhibited. Further, the reference image includes a characteristic pattern having a predetermined characteristic.

The printer image detection part 303 stores the reference image as described above in advance, and detects whether or not print data includes a reference image by comparing the reference image and the print data for each reference image. The printer image detection part 303 transmits a detection result in response to a request from a read image detection part 315 of the reading control part 103. In addition, the printer image detection part 303 notifies the print processing part 304 of the detection result.

The print processing part 304 forms an image on a recording sheet supplied by the sheet feeding device 130, by using print data generated by the editing processing part 302. Note that the image formation is not executed in a case where the printer image detection part 303 notifies the detection result that the print data includes the reference image. Further, in FIG. 3, broken arrows indicate a flow of a recording sheet and printed matter.
(3-2) Functional Configuration of Reading Control Part 103

The reading control part 103 includes the quality confirmation part 311, a log processing part 312, a display part 313, and the like, and these functions are realized by the CPU 211 executing a control program.

A reading processing part 317 uses the line scanners 101 and 102 to read printed matter outputted by the printer device 120, and generates scan data.

The quality confirmation part 311 acquires print data from the editing processing part 302, compares the print data with the scan data, and determines whether or not the print data and the scan data match. If the print data and scan data do not match, it can be estimated that there is a problem in print quality, such as breakage or wrinkle on the printed matter, or that some image is attached on the recording sheet.

A registration mark detection part 316 detects whether or not scan data includes a registration mark. The registration mark is a mark for matching a finished size of printed matter and register of multicolor printing, and is also called a register index, a register mark, or a trim mark. The print processing part 304 performs printing inside an area having the registration marks at the four corners (hereinafter referred to as “registration mark inside area”). Hereinafter, in the scan data, the outside of the area having the registration marks at the four corners is referred to as “registration mark outside area”.

The read image detection part 315 sequentially compares reference images stored in advance with image data, to detect whether or not a reference image is included in the scan data (particularly, the registration mark outside area) and in reversely scaled data. Further, the read image detection part 315 acquires a detection result as to whether or not the print data includes a reference image, from the printer image detection part 303. Note that, in the present embodiment, the read image detection part 315 stores the same reference image as the reference image stored in the printer image detection part 303.

The reverse scaling processing part 314 acquires a scaling factor M of print data corresponding to scan data, from the editing processing part 302 of the printer control part 122, to generate image data (hereinafter referred to as “reversely scaled data”) obtained by reverse scaling of the scan data. Here, the reverse scaling refers to processing for scaling scan data with a scaling factor that is a reciprocal (1/M) of the scaling factor M acquired from the editing processing part 302.

The log processing part 312 creates an image log and a display screen nail image for each piece of printed matter. The image log includes a quality confirmation result by the quality confirmation part 311, a detection result by the read image detection part 315, and scan data. Further, the display screen nail image is a thumbnail image obtained by reducing the image log.

The display part 313 displays a list of display screen nail images generated by the log processing part 312, on the touch panel 215. When the user of the multi-function peripheral 1 touches any display screen nail image, an image log corresponding to the display screen nail image is displayed on the touch panel 215.

A cutting processing part 318 controls an orientation of the path switching claw 105 to guide printed matter to the cutting roller 108, cuts the printed matter, and discards cutting waste into the cutting waste container 109. In a case where cutting is not performed, the cutting processing part 318 controls an orientation of the path switching claw 105 to guide the printed matter to the finisher device 140. In a case where post-processing is specified in a print job, the printed matter is post-processed by the post-processing device 143 and then discharged to the sheet discharging tray 144. In a case where post-processing is not performed, the printed matter is discharged to the sheet discharging tray 142 as it is.

### [3] Operation of Printer Control Part 122

Next, an operation of the printer control part 122 will be described.

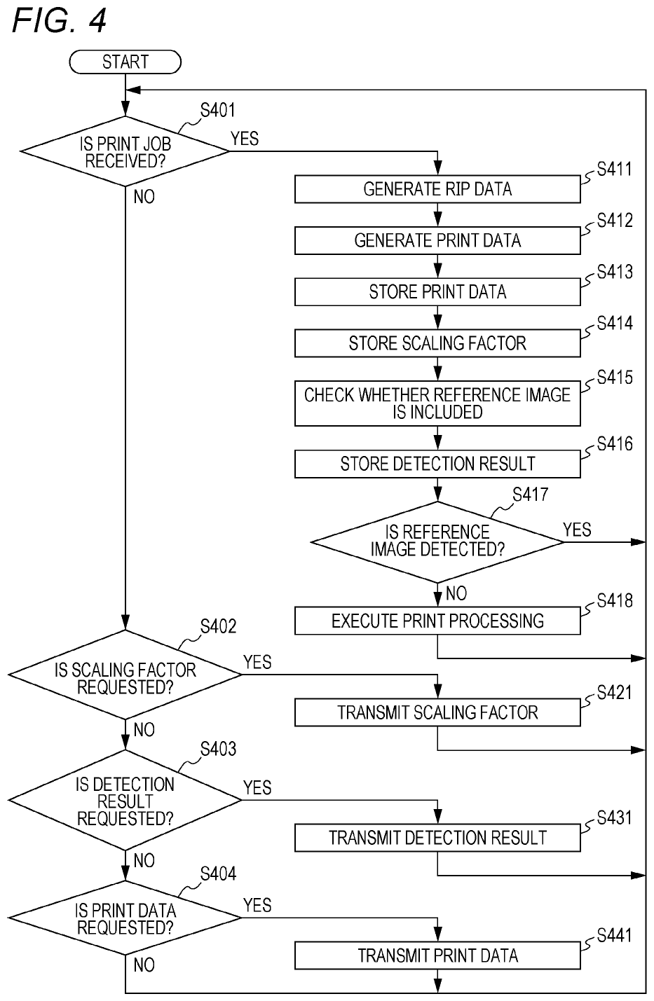

As shown in FIG. 4, when the printer control part 122 receives a print job (S401: YES), the RIP part 301 generates RIP data from image data included in the print job (S411), and the editing processing part 302 edits the RIP data to generate print data (S412). The editing processing part 302 may scale the RIP data when generating the print data.

After generating the print data, the editing processing part 302 stores the print data (S413) and stores a scaling factor (S414). Note that, in a case where the scaling processing is not performed when the print data is generated by editing the RIP data, 1 is stored as the scaling factor.

Next, the printer image detection part 303 checks whether or not the print data includes a reference image (S415), and stores the detection result (S416). When the print data does not include the reference image (S417: NO), print processing is executed using the print data (S418), and the process proceeds to step S401. When the print data includes the reference image (S417: YES), the process proceeds to step S401 without executing the print processing.

In a case where the scaling factor at a time when the editing processing part 302 edits the RIP data to generate the print data is requested from the reverse scaling processing part 314 of the reading control part 103 (S402: YES), the editing processing part 302 transmits the scaling factor to the reverse scaling processing part 314 (S421).

When the detection result by the printer image detection part 303 is requested from the read image detection part 315 of the reading control part 103 (S403: YES), the printer image detection part 303 transmits the detection result to the read image detection part 315, which is the request source (S431).

When print data is requested from the quality confirmation part 311 of the reading control part 103 (S404: YES), the editing processing part 302 transmits the print data to the quality confirmation part 311 (S441).

### [4] Operation of Reading Control Part 103

Next, an operation of the reading control part 103 will be described.

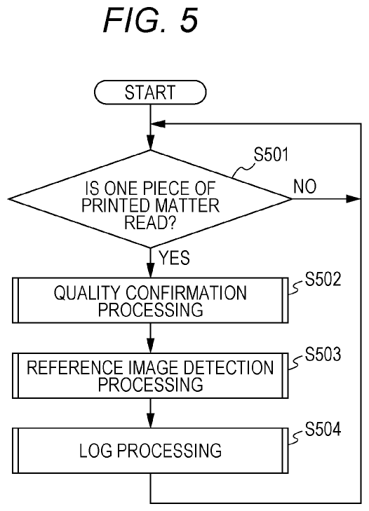

As shown in FIG. 5, when the reading control part 103 reads one piece of printed matter in the reading processing part 317 to generate scan data (S501: YES), quality confirmation processing (S502), reference image detection processing (S503), and log processing (S504) are sequentially executed.
(4-1) Quality Confirmation Processing (S502)

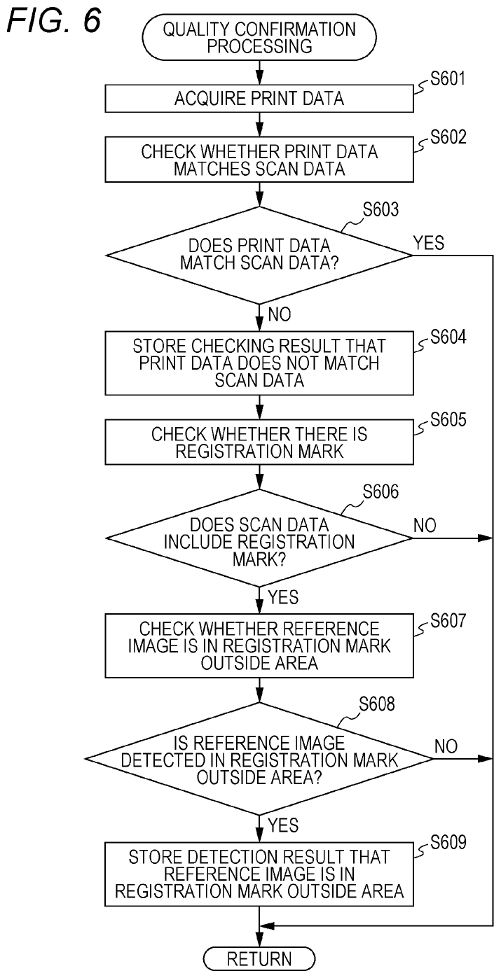

In the quality confirmation processing (S502), as shown in FIG. 6, the quality confirmation part 311 acquires print data from the editing processing part 302 of the printer control part 122 (S601), and checks whether the acquired print data matches scan data (S602). When the print data matches the scan data (S603: YES), the process returns to the main routine shown in FIG. 5 to execute the reference image detection processing (S503), since it is considered that there is no problem in the quality of the printed matter.

When the print data does not match the scan data (S603: NO), the read image detection part 315 stores the checking result that the print data does not match the scan data (S604), and then checks whether or not the scan data includes a registration mark (S605). When a registration mark is included (S606: YES), the read image detection part 315 checks whether or not a reference image is included in a registration mark outside area of the scan data (S607).

In a case where an image of a banknote or the like is attached on a registration mark inside area, if the attached image is overwritten by print data, it is not possible to create scan data of the attached image with high accuracy. For this reason, it is expected that a banknote or the like will not be attached to the registration mark inside area but will be attached to the registration mark outside area when it is intended to create unauthorized scan data. Therefore, in the present embodiment, it is checked whether or not a reference image is included in the registration mark outside area of the scan data.

When the reference image is included in the registration mark outside area (S608: YES), the detection result that the reference image is included in the registration mark outside area is stored (S609), and the process returns to the main routine. When the reference image is not included in the registration mark outside area (S608: NO), and when the registration mark is not included in the scan data (S606: NO), the process returns to the main routine as it is.
(4-2) Reference Image Detection Processing (S503)

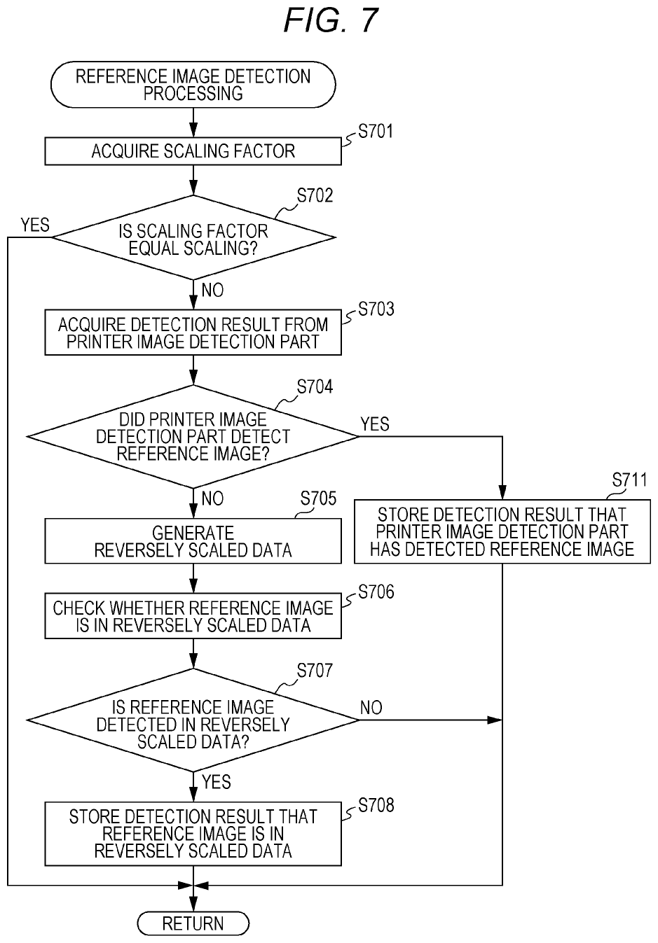

In the reference image detection processing (S503), as shown in FIG. 7, the reverse scaling processing part 314 acquires a scaling factor from the editing processing part 302 of the printer control part 122 (S701), and the process returns to the main routine when the obtained scaling factor is equal scaling (S702: YES). When the obtained scaling factor is not equal scaling (S702: NO), the read image detection part 315 acquires a detection result by the printer image detection part 303 (S703).

When the detection result by the printer image detection part 303 is positive, in other words, when the printer image detection part 303 determines that the print data includes a reference image (S704: YES), the printer device 120 stores the fact that the reference image has been detected in the print data (S711), and the process returns to the main routine. When the detection result by the printer image detection part 303 is negative (S704: NO), the reverse scaling processing part 314 generates reversely scaled data by reversely scaling the scan data (S705), and the read image detection part 315 checks whether or not the reversely scaled data includes a reference image (S706).

When the detection result by the read image detection part 315 is positive, in other words, when the reversely scaled data includes the reference image (S707: YES), the detection result that the reversely scaled data includes the reference image is stored (S708), and the process returns to the main routine. When the reversely scaled data does not include the reference image (S707: NO), the process returns to the main routine as it is.
(4-3) Log Processing (S504)

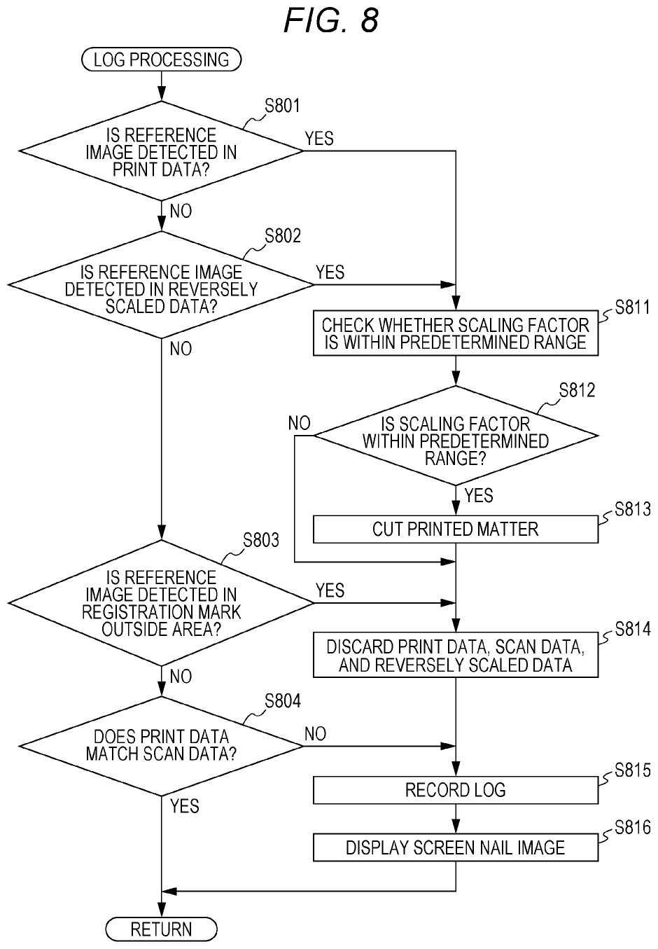

In the log processing (S504), as shown in FIG. 8, when the printer image detection part 303 detects that the print data includes the reference image (S801: YES), and when the read image detection part 315 detects that the reversely scaled data includes the reference image (S802: YES), the read image detection part 315 checks whether or not a scaling factor is within a predetermined range (S811). In the present embodiment, the predetermined range is 95% to 105%, but another range may be used as long as the range includes equal scaling (100%).

When the scaling factor is within the predetermined range (S812: YES), the printed matter is cut by the cutting processing part 318 (S813) and discarded into the cutting waste container 109. For example, if the print data is a banknote image and is close to the original size (equal scaling), the image is easily confused with a banknote and may be abused as a forged banknote. Therefore, such abuse can be suppressed by cutting the printed matter when the scaling factor is close to equal scaling.

After the cutting processing in step S813 and when the scaling factor is out of the predetermined range (S812: NO), the print data, the scan data, and the reversely scaled data are discarded (S814). This disables duplication of the printed matter using these data, making it possible to suppress unauthorized duplication of printed matter for which duplication is prohibited, such as banknotes, and suppress leakage of confidential information due to document duplication.

Thereafter, the log processing part 312 generates an image log and a display screen nail image obtained by reducing the image log, and records the image log (S815). When the printer image detection part 303 detects a reference image in the print data (S801: YES), this image log includes indication that the printer image detection part 303 has detected the reference image in the print data. Further, when the read image detection part 315 detects a reference image in the reversely scaled data (S802: YES), the image log includes indication that the reference image has been detected in the reversely scaled data.

Thereafter, the display part 313 displays the display screen nail image on the touch panel 215 (S816), and the process returns to the main routine. Note that, in a case where the scan data has been discarded, the log processing part 312 generates an image log that does not include the scan data. Of course, the scan data is not included also in the display screen nail image generated from the image log not including the scan data.

When the reference image is not detected in the print data or the reversely scaled data (S802: NO), and a reference image is detected in the registration mark outside area in the scan data (S803: YES), steps S814, S815, and S816 are executed similarly to that described above. In other words, the print data, the scan data, and the reversely scaled data are discarded, the image log is recorded including indication that a reference image has been detected in the registration mark outside area, the display screen nail image is displayed on the touch panel 215, and the process returns to the main routine.

When the reference image is not detected in the registration mark outside area of the scan data (S803: NO), and the print data does not match the scan data (S804: NO), an image log including indication that the print data does not match the scan data is recorded (S815), the display screen nail image is displayed on the touch panel 215 (S816), and the process returns to the main routine. Further, when the print data matches the scan data (S804: YES), the process returns to the main routine as it is.

Note that, in a case where the printed matter is not cut, the printed matter is outputted to the finisher device 140.

### [5] Effects

Effects of the present embodiment will be described.

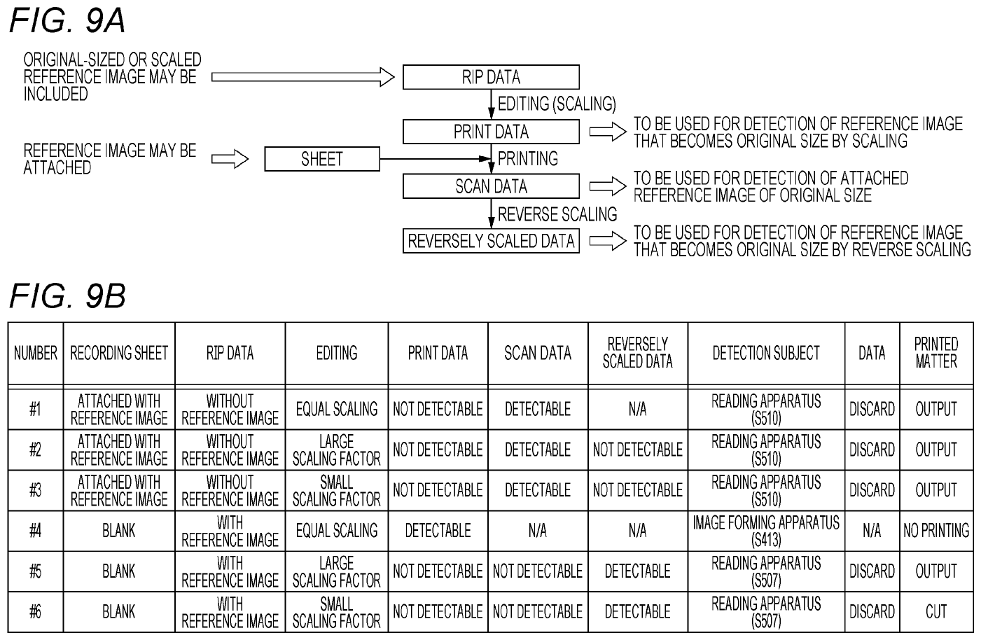

As shown in FIG. 9A, in a case where an inhibited image including a reference image, such as a banknote, is attached to a recording sheet, the printer device 120 is not able to detect the reference image by using print data since this attachment does not cause the reference image to be included in the RIP data and the print data.

Further, as in the case #1 in FIG. 9B, in a case where a scaling factor at a time of creating print data from RIP data is equal scaling, the printer device 120 can detect a reference image included in the print data. Therefore, when the scaling factor is equal scaling and the printer device 120 has not detected the reference image in the print data, it is desirable to omit detection processing in the reading apparatus 100 since the processing load is just uselessly generated even if the detection processing is performed in the reading apparatus 100.

However, if the detection processing in the reading apparatus 100 is omitted as described above, in a case where the reference image is not included in the RIP data and the inhibited image is attached to the recording sheet, it becomes no longer possible to detect the reference image included in the inhibited image attached to the recording sheet, since printing processing is permitted in the printer device 120 since the print data does not include the reference image while the detection processing is omitted in the reading apparatus 100 since the scaling factor is equal scaling. As a result, if scan data including an inhibited image is saved in the reading apparatus 100, the saved scan data may be abused.

Furthermore, as in the cases #2 and #3 in FIG. 9B, in a case where the scaling factor at a time of creating print data from RIP data is not equal scaling, the reverse scaling processing part 314 reversely scale the scan data, and then the read image detection part 315 checks whether or not the reversely scaled data includes a reference image. Therefore, in a case where an inhibited image is attached to the recording sheet, the inhibited image and the reference image included in the inhibited image are equal scaling in the scan data read from the recording sheet, while both the inhibited image and the reference image included in the inhibited image are not equal scaling or the original size any more due to reverse scaling in reversely scaled data obtained by reverse scaling the scan data. Since the read image detection part 315 exclusively detects a reference image of equal scaling, it is not possible to detect the reference image that is no longer equal scaling due to reverse scaling. As a result, scan data including the inhibited image to be saved.

For such a problem, as shown in FIG. 6, in a case where print data does not match scan data, detection is possible by detecting whether or not the scan data includes a reference image, since the reference image included in the scan data is equal scaling even if the inhibited image is attached to the recording sheet. Further, the scan data is not reversely scaled unlike the reversely scaled data, so that the reference image can be detected regardless of the scaling factor in the editing processing part 302. Therefore, an unauthorized act of saving scan data including an inhibited image can be inhibited.

Note that, when the inhibited image is not attached to the recording sheet, the printed matter is not to be conveyed to the reading apparatus 100 as long as the scaling factor is equal scaling as in the case #4 in FIG. 9B, since the printer device 120 detects the reference image included in the print data and inhibits the printing processing. Therefore, it is possible to inhibit the scan data including the inhibited image from being saved in the reading apparatus 100.

Further, as in the case #5 in FIG. 9B, when a scaling factor is far from equal scaling, it is possible to inhibit scan data including an inhibited image from being saved since the reading apparatus 100 detects a reference image included in reversely scaled data. In addition, when the scaling factor is far from equal scaling, there is no problem even if printout is performed, since there is no possibility that the printed matter and the actual inhibited image are confused.

Whereas, as in the case #6 in FIG. 9B, also in a case where a scaling factor is close to equal scaling, the reading apparatus 100 detects a reference image included in reversely scaled data, and inhibits scan data including an inhibited image from being saved. Further, in this case, the printed matter is cut since the printed matter and the actual inhibited image may be confused.

Note that, in any of the above cases, it is possible to determine the presence or absence of an inhibited image by using a reference image of the original size. Therefore, it is possible to reduce the processing load on the reading apparatus 100 and the printer device 120 that are necessary for detecting the reference image, as compared to a case of determining the presence or absence of the inhibited image by using reference images of various scaling factors considering that RIP data is to be scaled.

### [6] Modification

Although the present invention has been described based on the embodiment, needless to say that the present invention is not limited to the above-mentioned embodiment, and the following modification can be implemented.
(6-1) In the above embodiment, as an example, a case has been described where it is checked whether or not a reference image is included in the registration mark outside area when print data does not match scan data (S603: NO). However, it is needless to say that the present invention is not limited to this. It may be checked whether or not the reference image is included in the registration mark inside area in addition to the registration mark outside area, and the print data, the scan data, and the reversely scaled data may be discarded when the reference image is included either in the registration mark outside area or the registration mark inside area, in other words, included in the scan data.

This enables detection of the reference image since the scan data is used, while it is not possible to detect a reference image included in an inhibited image attached to a recording sheet by using reversely scaled data in a case where the inhibited image is attached to the registration mark inside area of the recording sheet, and a scaling factor at a time when the printer device 120 edits print data from RIP data is not equal scaling.

Note that, when an inhibited image is not included in RIP data, it is also effective to simply discard scan data and reversely scaled data since the inhibited image is also not included in print data.
(6-2) In the above embodiment, as an example, a case has been described where the quality confirmation processing (step S502) is executed after the reading processing part 317 generates the scan data by using the line scanners 101 and 102 to read printed matter one by one from a leading edge to a rear edge. However, it is needless to say that the present invention is not limited to this, and the following may be used instead.

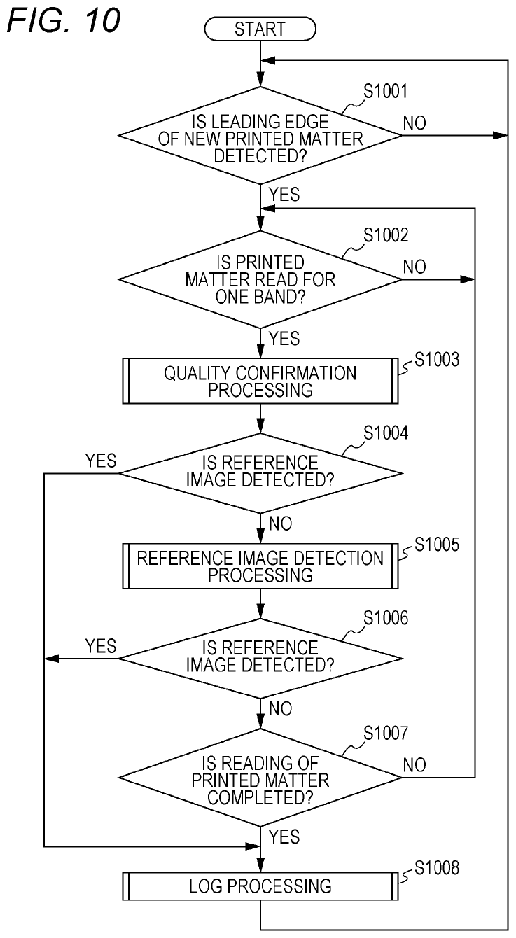

For example, as shown in FIG. 10, when the reading processing part 317 detects a leading edge of new printed matter (S1001: YES), the reading control part 103 starts generating scan data. When the reading processing part 317 reads the printed matter for one band and generates scan data for the one band (S1002: YES), the quality confirmation processing is executed (S1003). When a reference image is detected in the quality confirmation processing (S1004: YES), the log processing is executed (S1008). When a reference image is not detected in the quality confirmation processing (S1004: NO), the reference image detection processing is executed (S1005).

When a reference image is detected in the reference image detection processing (S1006: YES), the log processing is executed (S1008). When a reference image is not detected in the reference image detection processing (S1006: YES), and it is determined that the one band is not a band that is read at the end of the printed matter and the reading of the printed matter has not been yet completed (S1007: NO), the process proceeds to step S1002 to repeat the above processing.

Whereas, when it is determined that the reading of the printed matter has been completed (S1007: YES), the log processing (S1008) is executed. After the log processing is completed, the process proceeds to step S1001 to wait for detection of a leading edge of the next printed matter.

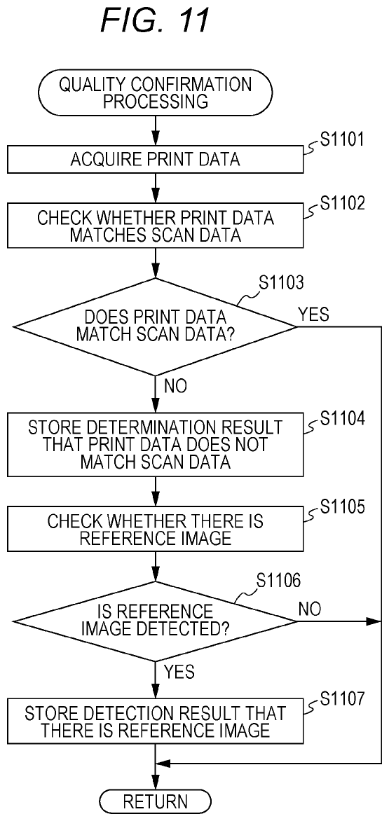

In the quality confirmation processing (S1003), as shown in FIG. 11, the quality confirmation part 311 acquires print data from the editing processing part 302 of the printer control part 122 (S1101), and checks whether the acquired print data matches scan data for the band part (S1102). When the print data matches the scan data (S1103: YES) for the band part, the process returns to the main routine shown in FIG. 10, to execute the reference image detection processing (S1005).

When the print data does not match the scan data (S1103: NO), the read image detection part 315 stores the checking result that the print data does not match the scan data (S1104), and then checks whether or not the scan data includes a reference image (S1105). In this modification, since processing is performed in band units without waiting until the presence or absence of all four registration marks can be confirmed, the reference image is detected without distinguishing between the registration mark inside area and the registration mark outside area.

When the reference image is included (S1106: YES), the detection result that the reference image is included is stored (S1107), and the process returns to the main routine. When the reference image is not included (S1106: NO), the process returns to the main routine as it is.

The reference image detection processing (S1005) is similar to the reference image detection processing (S503) in the above embodiment, except being different in that the processing is performed in band units of scan data instead of scan data units. The log processing (S1008) is similar to the log processing (S504) in the above embodiment.

This enables the processing to be completed earlier, as compared with the case where the quality confirmation processing, the reference image detection processing, and the log processing are executed after reading up to a rear edge of printed matter, making it possible to improve productivity of the reading apparatus 100, and thus of the printer device 120.

Note that adjacent bands on printed matter may overlap with each other, and this makes it possible to suppress deterioration of detection accuracy of an inhibited image due to the reference image being divided at a boundary between bands.
(6-3) In the above embodiment, as an example, a case has been described where the recording sheet printed with the inhibited image is cut. However, it is needless to say that the present invention is not limited to this, and the following may be used instead.

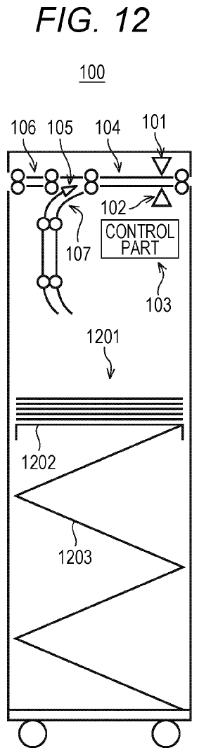

For example, as shown in FIG. 12, it is possible to store the recording sheet instead of cutting, by providing a recording sheet container 1201 inside the reading apparatus 100. The recording sheet container 1201 is arranged with a sheet tray 1202 to be placed with a recording sheet bundle, and a support member 1203 to support the sheet tray 1202. The support member 1203 supports the sheet tray 1202 such that a position of the sheet tray 1202 becomes lower as the number of recording sheets placed on the sheet tray 1202 increases.

Further, when an unspecified number of persons access the recording sheets contained in the recording sheet container 1201, there is a risk that printed matter printed with an inhibited image is illicitly used. In order to prohibit such access, the recording sheet container 1201 is locked, and a person other than the administrator of the multi-function peripheral 1 is not able to access the recording sheets contained in the recording sheet container 1201.

This can also suppress unauthorized use of printed matter printed with an inhibited image.
(6-4) In the above embodiment, as an example, a case has been described where, in step S705 of FIG. 7, the reverse scaling processing part 314 generates reversely scaled data by reversely scaling the entire scan data. However, it is needless to say that the present invention is not limited to this, and the following may be used instead.

For example, the reverse scaling processing part 314 may generate reversely scaled data by performing reverse scaling exclusively on the registration mark inside area in scan data. Since there is no scan data corresponding to print data for the registration mark outside area, and the scan data is obtained by reading an image attached to a recording sheet and has not been subjected to the scaling processing by the editing processing part 302, it is sufficient to detect a reference image in the quality confirmation processing (S502).

This can reduce a data amount of the reversely scaled data, making it possible to reduce the processing load for detecting a reference image included in reversely scaled data.
(6-5) In the above modification, as an example, a case has been described where it is always detected whether or not reversely scaled data includes a reference image. However, it is needless to say that the present invention is not limited to this, and the following may be used instead.

For example, in a case where RIP data is blank, the RIP data itself does not include an inhibited image, and therefore it is not necessary to generate reversely scaled data. If scan data includes an inhibited image, it is to be exclusively when an inhibited image is attached to a recording sheet. In this case, the reference image can be detected in the quality confirmation processing (S502).

For this reason, the processing load on the reading control part 103 can be reduced, since it is possible to omit the detection processing in a case where the reference image is clearly not included in the reversely scaled data, by the reading control part 103 obtaining RIP data from the printer control part 122 and determining whether or not the RIP data is blank, and the read image detection part 315 detecting whether or not reversely scaled data includes a reference image exclusively when the RIP data is not blank.

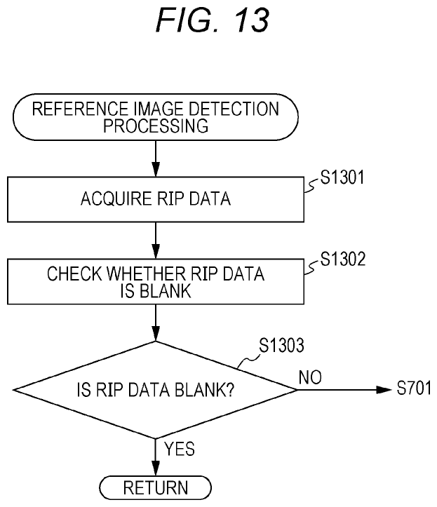

FIG. 13 is a flowchart showing processing to be inserted at the beginning of the flowchart of FIG. 7. As shown in FIG. 13, when the reference image detection processing (S503) is started, first, the reading control part 103 acquires RIP data from the RIP part 301 of the printer control part 122 (S1301), and checks whether or not the RIP data is blank (S1302).

When the RIP data is not blank (S1303: NO), the process proceeds to step S701, and the reverse scaling processing part 314 acquires a scaling factor from the editing processing part 302. When the RIP data is blank (S1303: YES), the process returns to the main routine.

This can omit useless detection processing, making it possible to reduce the processing load on the reading control part 103.
(6-6) In the above embodiment, as an example, a case has been described where the line scanners 101 and 102 included in the reading apparatus 100 are color scanners. However, it is needless to say that the present invention is not limited to this, and the line scanners 101 and 102 may also be monochrome scanners in a case where the printer device 120 is a monochrome printer. Also in this case, the effect can be obtained by applying the present invention.
(6-7) Although not particularly mentioned in the above embodiment, the multi-function peripheral 1 may perform user authentication before the user starts using, and the log processing part 312 of the reading apparatus 100 may acquire a login name of the user from the printer device 120 and enter the login name into the image log. This facilitates identification of the user who has tried to illicitly print the inhibited image, making it possible to restrain such unauthorized acts.
(6-8) The above embodiment has not particularly mentioned a method for saving an image log and a display screen nail image by the log processing part 312. However, the image log and the display screen nail image may be saved in the HDD 214, or may be saved in a memory card such as a compact flash (registered trademark) or smart media, by mounting a card reader/writer on the reading control part 103.

Even in a case of saving the image log and the like in a storage device that can be inserted into and removed from the reading control part 103, according to the present invention, it is possible to efficiently detect an inhibited image and delete scan data including the inhibited image from the image log and the like. Therefore, unauthorized use of inhibited images can be reliably suppressed.
(6-9) In the above embodiment, the multi-function peripheral 1 has been described as an example. However, it is needless to say that the present invention is not limited to this, but may be a multi-function peripheral that excludes the scanner device 110 and the finisher device 140, or may exclude the facsimile function. Further, a case where the printer device 120 is a tandem color printer has been described as an example, but the printer device 120 may be a color printer other than a tandem type, or may be a monochrome printer.

As long as the apparatus includes at least the reading apparatus 100, the printer device 120, and the sheet feeding device 130, the above-described effects can be obtained by applying the present invention.
(6-10) In the above embodiment, as an example, a case has been described where a print job is received by the network interface card (NIC) 205 via a communication network such as a local area network (LAN), but may be received by other communication means, such as Bluetooth (trademark).

The image reading apparatus according to an embodiment of the present invention is useful as an apparatus that can inhibit creation of inhibited image data.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image reading apparatus comprising:
a hardware processor that acquires scan data obtained by reading from printed matter outputted by an image forming apparatus;
an acquisitor that acquires print data used for image formation of the printed matter from the image forming apparatus;
a first determiner that compares the scan data and the print data and detects whether or not the scan data and the print data match;
a second determiner that determines whether or not a predetermined reference image is included in the scan data when a determination result by the first determiner is negative; and
a first discarder that causes the scan data to be discarded when a determination result by the second determiner is positive.

2. The image reading apparatus according to claim 1, wherein
the hardware processor detects a registration mark in the scan data, and
the first determiner determines as unmatched when there is an image other than the registration mark outside an image area defined by the registration mark.

3. The image reading apparatus according to claim 1, wherein
the second determiner divides an area of the scan data into a plurality of blocks and executes the determination in units of the blocks.

4. The image reading apparatus according to claim 3, further comprising:
a scaling factor acquisitor that acquires a scaling factor at a time of image formation of the printed matter, from the image forming apparatus,
the hardware processor scaling a block for which a determination result by the second determiner is positive, by a scaling factor that is a reciprocal of a scaling factor acquired by the scaling factor acquisitor;
a third determiner that determines whether or not a predetermined reference image is included in a block scaled by the hardware processor; and
a second discarder that causes scan data recorded by the hardware processor to be discarded when there is a block for which a determination result by the third determiner is positive.

5. The image reading apparatus according to claim 3, further comprising:
a scaling factor acquisitor that acquires a scaling factor at a time of image formation of the printed matter, from the image forming apparatus;
a scaling part that scales the predetermined reference image by a scaling factor acquired by the scaling factor acquisitor;
a fourth determiner that determines whether or not a predetermined reference image scaled by the scaling part is included in a block for which a determination result by the second determiner is positive; and
a third discarder that causes scan data recorded by the hardware processor to be discarded when there is a block for which a determination result by the fourth determiner is positive.

6. The image reading apparatus according to claim 1, further comprising:
a print data acquisitor that acquires print data from the image forming apparatus;
a scaling factor acquisitor that acquires a scaling factor at a time of image formation of the printed matter, from the image forming apparatus;
a fifth determiner that determines whether or not the predetermined reference image is included as it is, for a white background area where toner image formation is not planned in the print data in the scan data, and
scales by a scaling factor that is a reciprocal of a scaling factor acquired by the scaling factor acquisitor and then determines whether or not the predetermined reference image is included, for an area other than the white background area; and
a fourth discarder that causes scan data recorded by the hardware processor to be discarded when there is a block for which a determination result by the fifth determiner is positive.

7. The image reading apparatus according to claim 1, further comprising:
a print data acquisitor that acquires print data from the image forming apparatus;
a scaling factor acquisitor that acquires a scaling factor at a time of image formation of the printed matter, from the image forming apparatus;
a sixth determiner that determines whether or not the predetermined reference image is included as it is, for a white background area where toner image formation is not planned in the print data in the scan data, and
scales the predetermined reference image by a scaling factor acquired by the scaling factor acquisitor and then determines whether or not the scaled image is included, for an area other than the white background area; and
a fifth discarder that causes scan data recorded by the hardware processor to be discarded when there is a block for which a determination result by the sixth determiner is positive.

8. The image reading apparatus according to claim 3, wherein
the first determiner divides an area of the scan data into a plurality of blocks and executes the determination in units of the blocks.

9. The image reading apparatus according to claim 1, wherein
the reference image includes a characteristic pattern having a predetermined characteristic.
